(19) United States
(12) Patent Application Publication
(10) Pub. No.: US 2019/0343091 A1
(43) Pub. Date: Nov. 14, 2019

(54) AN AQUAPONICS SYSTEM

(71) Applicant: Tal WEINER, Givatayim (IL)

(72) Inventor: Tal WEINER, Givatayim (IL)

(21) Appl. No.: 16/347,584

(22) PCT Filed: Nov. 18, 2017
(86) PCT No.: PCT/IL2017/051258

§ 371 Date: May 5, 2019

Related U.S. Application Data
(60) Provisional application No. 62/424,695, filed on Nov. 21, 2016.

(51) Int. Cl. A01K 63/04; A01G 27/00; A01G 31/02

(52) U.S. Cl. CPC A01K 63/045; A01K 63/047; A01G 24/18; A01G 31/02; A01G 27/005

(57) ABSTRACT

A self-contained closed aquaponics system comprises an aquarium tank attached side-by-side to a water container for growing plants, having a shared side. An electrically powered water pump streams the water from the aquarium tank via a pipe to the bottom of a compartment in the water container. When the water in the water tank exceeds a pre-set water level, the water are poured back to the aquarium tank via a recess or slit in the shared side. The compartment may comprise a bio-filter that is a sponge filter, a foam cartridge filter and the undergravel filter. The aquarium tank or the water container may be rectangular or cuboid shaped. A cover adapted to cover the water container may include multiple openings for mounting plants in pot nets therein, where roots of the plants are fed from the fish excretions in the aquarium tank after being filtered by the bio-filter.

### TECHNICAL FIELD

This disclosure relates generally to an aquaponics system combining plants and fish growth for growing soil-grown plants in a soil-less environment; and in particular to an aquaponics system structured as a single structure and using a filter.

### BACKGROUND

Hydroponics is a known method of growing plants without soil, using mineral nutrient solutions in a water solvent. Plants may be grown with only their roots exposed to the mineral solution, or the roots may be supported by an inert medium, such as hydroton, perlite, rockwool, clay pellets, peat moss or gravel. The nutrients in hydroponics can come from an array of different sources; including, but is not limited to, byproduct from fish waste, duck manure, or normal nutrients.

A hydroponic bed may be composed of Acrylonitrile Butadiene Styrene (ABS), High-Density Polyethylene (HDPE), Poly Vinyl Chloride (PVC), polycarbonate, glass or any other suitable material commonly utilized in the aquaculture, aquarium and/or hydroponic industries.

Hydroponics system or apparatus is disclosed, for example, in CN Publication No. 105684868A, U.S. Pat. Nos. 4,794,728 and 4,581,848.

Aquaponics refers to any system that combines conventional aquaculture (raising aquatic animals such as snails, fish, crayfish or prawns in tanks) with hydroponics in a symbiotic environment. In normal aquaculture, excretions from the animals being raised in the water can accumulate and increase the toxicity. In an aquaponics system, water from an aquaculture system is fed to a hydroponic system where the by-products are broken down by nitrifying bacteria initially into nitrites and subsequently into nitrates, which are utilized by the plants as nutrients, and the water is then recirculated back to the aquaculture system. Most of the aquaculture systems having a closed-system recirculation.

The effluent-rich water becomes toxic to the aquatic animal in high concentrations but also contains nutrients essential for plant growth. Aquaponics systems are usually grouped into several components or subsystems responsible for effective removal of solid wastes, adding bases to neutralize acids, and maintaining water oxygenation. Typical components of aquaponics system include: rearing tank for raising and feeding the fish; settling basin, a unit for catching uneaten food and detached biofilms, and for settling out fine particulates; biofilter, a place where the nitrification bacteria can grow and convert ammonia into nitrates which are used by the plants; hydroponics subsystem, the portion of the system where plants are grown by absorbing excess nutrients from the water; and pump, the lowest point in the system where the water flows to and from which it is pumped back to the rearing tanks.

Aquaponics systems do not typically discharge or exchange water under normal operation, but instead recirculate and reuse water very effectively. The aquaponics system relies on the relationship between the animals and the plants and maintains a stable aquatic environment having a minimum fluctuation in ambient nutrients and oxygen levels. Plants are able to recover the dissolved nutrients from the circulating water, which leads to less discharge of water and minimize water exchange rate. Water is added only to replace water loss from absorption and transpiration by plants or evaporation into the air from surface water. As a result, aquaponics uses approximately 2% of the water that a conventionally irrigated farm requires for the same vegetable production. This allows for aquaponics production of both crops and fish in the areas where water or fertile land is scarce. Aquaponics systems can also be used to replicate controlled wetland conditions.

An aquarium is a water-filled tank of any size, having at least one transparent side in which water-dwelling plants or animals are kept and displayed. An aquarium is typically constructed of glass or high-strength acrylic. Cuboid aquariums are also known as fish tanks or simply tanks, while bowl-shaped aquariums are also known as fish bowls.

A pump is a device that moves fluids (liquids or gases), or sometimes slurries, by mechanical action. Pumps operate by some mechanism (typically reciprocating or rotary), and consume energy to perform mechanical action by moving the fluid. Pumps operate via many energy sources, including manual operation, electric engines, or wind power and come in many sizes, from microscopic for use in medical applications, to large industrial pumps. Mechanical pumps serve in a wide range of applications such as aquarium filtering.

Fish tanks produce waste from excrement and respiration. Another source of waste is uneaten food or plants, and died fish. These waste products collect in the tanks and contaminate the water. As the degree of contamination rises, the risk to the health of the fish in the aquarium increases and removal of the contamination becomes critical. Proper management of the nitrogen cycle is a vital element of a successful aquarium. Excreta and other decomposed organic matter produce ammonia which is highly toxic to fish. Bacterial processes oxidize this ammonia into the slightly low toxic nitrites, and these are in turn oxidized to form the much lower toxic nitrates. In the natural environment these nitrates are subsequently taken up by plants as fertilizer and a similar process happen to some extent in an aquarium planted with real plants.

Pot net baskets (a.k.a mesh pots) are plants growth accessories, which are made in different sizes and shapes. The pot net usually has a top outer circular edge or a block edge design. The pot nets are suitable for a variety of soilless cultivation equipment and usually made of plastic and poly ethylene.

Filtration is a common method used for maintaining the health of the aquarium. There are three types of filtration: mechanical, chemical, and biological. Mechanical filtration is the process where water is forced through a filter media which is designed to catch particles suspended in the aquarium water. Chemical filtration occurs when toxic chemicals pass through a resin or media. Some chemical filtration products target specific excessive nutrients or chemicals from the aquarium. Biological filtration is the breakdown of different bacteria, typically referred to as the nitrogen cycle where waste products, food, and fungi are broken down to create ammonia. Ammonia is toxic to the aquariums inhabitants, and if there is sufficient space for the beneficial bacteria to grow, the nitrogen cycle will work properly. A biological filter is designated by the amount of space available for the bacteria to grow on.

Numerous types of aquarium filters are commercially available, including: a sponge filter, such as XINYOU XY-2835 Fish Aquarium Mini Cylinder Soft Sponge Water Filter; Hang On Back/Power (HOB) Filters, such as AquaClear Power Filter; Canister filters, such as Penn Plax Cascade Canister Aquarium Filter; Internal filters such as Penn Plax Cascade 600 Submersible Aquarium Filter Cleans Up to 50 Gallon Fish Tank With Physical, Chemical, and Biological Filtration; and a fluidized bed filter (FBF), such as Lifegard Fluidized Bed Filter.

Internal filters include filters within the confines of the aquarium. These include the sponge filter, variations on the corner filter, foam cartridge filter and the undergravel filter. An internal filter may have an electric pump and thus can be an internal power filter, often attached to the inside of the aquarium via suction cups.

Sponge filters and corner filters (sometimes called box filters) work by essentially the same mechanism as the internal filter. Both generally work by airlift, using bubbles from an air pump rising in a tube to create flow. In a sponge filter, the inlet may only be covered by a simple open-cell block of foam. A corner filter is slightly more complex. These filters are often placed in the corner at the bottom of the aquarium. Water enters slits in the box, passes through a layer of medium, then exits through the airlift tube to return to the aquarium. These filters tend to be suitable only for small and lightly stocked aquariums. The sponge filter is especially useful for rearing fry, where the sponge prevents the small fish from entering the filter.

Algae may be grown purposely which removes chemicals from the water needed to have healthy fish, invertebrates and corals. This is a natural (“green”) filtering method, which lets an aquarium operate the way oceans and lakes operate.

Biofiltration is a pollution control technique using a bioreactor containing living material to capture and biologically degrade pollutants. The use of biofilters is common in closed aquaculture systems, such as Recirculating Aquaculture Systems. Recirculating Aquaculture Systems (RAS) are used where water exchange is limited and the use of biofiltration is required to reduce ammonia toxicity, such in home aquariumand for fish production. The main benefit of RAS is its ability to reduce the need for fresh, clean water while still maintaining a healthy environment for fish.

The combination of plants and fish in a RAS is referred to as aquaponics. In this type of system ammonia produced by the fish is not only converted to nitrate but is also removed by the plants from the water. In an aquaponics system fish effectively fertilize the plants creating a closed looped system where very little waste is generated and inputs are minimized.

The term ‘waterfall’ herein refers to a place where water flows over a vertical drop or a series of steep drops in the course of a stream or river. The waterfall causes a trickle water that creates oxygen bubbles.

U.S. Patent Application Publication No. 2014/0223819 to Coghlan discloses an inexpensive, complete integrated aquaponic aquarium system that uses air pressure to pump water and waste from the bottom of an aquarium into a planter where terrestrial plants are grown. Included in this system is an aquarium lighting system, unique undergravel funnel filter system, grow lights, aquarium heater, and a power regulation system that turns the grow light on and off in regular intervals.

U.S. Patent Application Publication No. 2015/0334996 to Licamele discloses a turnkey home aquaponics grow bed that comprises a hydroponic growing bed with a removable filter component, a depression in the hydroponic growing bed, a removable lid that houses plant and/or plants, and a port and/or hole for allowing water to flow out of the invention and into the fish tank. The present invention attaches to standard fish tank aquariums, converting the fish tank aquariums into a home aquaponics gardening kit. The present invention enables a user not skilled in the art to grow fresh aquaponics herbs, microgreens, medicinal plants, and vegetables in their home using a freshwater aquarium.

FIG. 6 of U.S. Pat. No. 5,056,260 to Sutton utilizes the special vibration of motion, the semi-hydroponic system, aquatic animals such as fish, three waterfalls, water pump, water filters with charcoal, temperature monitor and growing units for the plants. In this system, the container has three separate, substantially identical, enclosed compartments arranged in a stair-step fashion. Each compartment has a top containing a plurality of openings, or in the alternative a layer of soil. At the upper end of one side of each compartment is an outlet which allows the water to flow from the water compartment into the next one of the compartments. Water discharged from compartment is collected in collector formed by a second wall and is recirculated by water pump through a line back to the uppermost compartment. Air is circulated into the water compartment of each of the compartments by pump through air lines.

Chinese Patent Publication No. CN104303981A describes a stepped aquaponic fish tank which comprises a base. A planting box is fixedly connected on the upper left side of the base, a planting table is fixedly connected in the rear of the right side of the planting box, a lamp holder is fixedly arranged in the rear of the planting table, a fish tank body is fixedly arranged in front of the planting table and lower than the planting table, the planting box is divided into an upper planting box and a lower planting box, the upper planting box is fixed on the lower planting box and communicated with the lower planting box through a pipeline, and the upper planting box is a hollow box with a wavy stepped structure, a planting groove, fences and a rear plate enclose the hollow box, the planting groove with a stepped structure is formed in the upper surface of the hollow box, and the wavy fences are arranged on two sides of the hollow box.

U.S. Patent Application Publication No. 2014/0041594 to Plante describes an aquaponic system that generally comprises an aquarium module, a garden module and a reservoir module. The aquarium module is generally configured to be installed on a supporting structure (e.g. a cabinet). The garden module is generally configured to be installed on the supporting structure near the aquarium module, in front, beside or even all around it. The garden module is generally configured to support terrestrial and/or semi-aquatic plants. The reservoir module is typically installed inside the supporting structure with the utilities (e.g. pumps). The system is generally designed such that the waste water from the aquarium module flows to the garden module where it irrigates the plants and where it is at least partially filtered by plants which consume at least some of the waste products contained in the water.

The Blue Green Box product (described in http://greenlivingideas.com/2013/07/29/the-blue-green-box-the-aquaponic s-aquarium/) uses a regular home aquarium system to grow plants with nutrients from fish waste, creating a mini-aquaponics system in the house. This system allows plants to grow much faster than normal. The Blue Green Box is a separate unit that is placed on the regular home aquarium. The Blue Green Box holds four grow beds which are plastic planters filled with gravel. Water floods the four grow-beds on timed intervals via a programmable timer and a small pump. The flooding of the roots is controlled by an overflow system and submersible pump. While in the on position, the excess water flows out of the overflow gate in the front. The gate guides the water into the aquarium silently, and is oversized to ensure no risk of clogging or flooding.

A complete line of aquaponic aquariums, from the counter top Mini System A to the multi-tier Large System C, along with powerful LED grow lights suitable for each system is described in “Fin to Flower Aquaponic Aquariums” website fintoflower.com (preceded by https://).

In consideration of the foregoing, it would be an advancement in the art to provide a home aquaponics system in a single enclosure that is simple, cost-effective, convenient, and easier to use.

### SUMMARY

A self-contained closed aquaponics system may comprise a first container configured to serve as an aquarium tank for containing aquatic animals and configured for containing water; a second container for growing plants configured for containing water at a first water level; a bio-filter in the second container for filtering out materials that affect the health of the aquatic animals and for fertilization of the water in the system; a pipe for transferring water from the first container to the bottom of the bio-filter; an electric pump connected to the pipe for streaming water from the first container to the bio-filter via the pipe; and a power supply cord for providing power connected to a common domestic AC power for providing electric power to the pump. The first container may be attached to the second container, and when the first water level exceed a pre-set water level, water may be poured from the second container to the first container so that the water level at the second container may not exceed the pre-set water level.

The first container may be rectangular or cuboid shaped having four side walls, the second container may rectangular or cuboid shaped having four side walls, and the first and second containers may be attached side-by-side, wholly or partially. A vertical side wall may be shared between the first and second containers, and the shared side wall may be having a recess, an opening, or a slit that may determine the pre-set water level. The system may be used with one or more soilless pot net baskets housing plants, and the system may further comprise a cover for covering at least part of the second container, and the cover may comprise one or more openings for mounting pot nets therein. The openings may be circular or rectangular shaped, and the roots of the plants in the pot nets may be immersed in the water in the second water container.

The material of the first or second container may comprise Acrylonitrile Butadiene Styrene (ABS), High-Density Polyethylene (HDPE), Poly Vinyl Chloride (PVC), polycarbonate, acrylic, or glass, and the aquatic animals may comprise snails, fish, crayfish or prawns.

The bio-filter may be operative to capture excrement or waste from the aquatic animals in the first container, to filter out materials that affect the health of the aquatic animals; and may further be operative to nitrifying bacteria into nitrites and subsequently into nitrates that may be used as nutrients by the plants in the second container. Further, the bio-filter may comprises, or may be based on, a sponge filter, a corner filter, a Hang On Back/Power (HOB) Filters, a canister filters, a Fluidized Bed Filter (FBF), a foam cartridge filter, an undergravel filter, square matala media, JBL Symec, XL Filterwool or algae. The bio-filter may comprise multiple layers of different materials.

The bio-filter may be separately located in the second container, and the second container may comprise a dedicated compartment for housing the bio-filter. For example, the second container may comprise a vertical wall for forming a cell for housing the bio-filter between the vertical wall and one of the side walls of the second container, so that when water in the cell may exceed a pre-set water level, water may be poured from the cell. The vertical wall may define a wall height that may determine the pre-set water level.

The length, the width, the height, the area, or the volume of the first container may be less than 70%, 60%, 50%, 40%, 30%, 20%, or 10% of the respective length, width, height, area, or volume of the second container. Alternatively or in addition, the length, the width, the height, the area, or the volume of the second container may be less than 70%, 60%, 50%, 40%, 30%, 20%, or 10% of the respective length, width, height, area, or volume of the first container.

The system may further comprise a single cover for covering at least part of the first container and at least part of the second water container, and the cover may be a flat plate for covering most of the first and second containers. The cover may be configured to allow access for replacing the bio-filter.

A vertical side wall may be shared between the first and second containers, and the vertical side may comprise an opening or a recess for passing through of the pipe between the first and second containers. Further, the system may further comprise a cover for covering at least part of the second container, the cover may comprise one or more openings and one or more soilless pot net baskets mounted therein, and the pot net baskets may comprise a plant in an inert medium. The inert medium may comprise, or may be based on, hydroton, perlite, rockwool, clay pellets, peat moss, or gravel, and the plant may comprise, or may be based on, a spice, a vegetable, a flower, an ornamental plant, an herb.

The second container may be mounted or located above the first container, where the first container may be rectangular or cuboid shaped having four side walls, and the second container may be rectangular or cuboid shaped having four side walls and a floor. The first container may be rectangular or cuboid shaped having four side walls and a cover covering at least part of the first container, and the cover of the first container may be the floor of the second container. One of the side walls may comprise a recess, an opening, or a slit that may determine the pre-set water level.

The first container may contain the second container, where the first container may be rectangular or cuboid shaped having four side walls, and the second container may be rectangular or cuboid shaped having at least one shared side wall with the first container and a floor. One of the side walls of the second container may comprise a recess, an opening, or a slit that may determine a pre-set water level.

### BRIEF DESCRIPTION OF THE DRAWINGS

The invention is herein described, by way of non-limiting examples only, with reference to the accompanying drawings, wherein like designations denote like elements. Understanding that these drawings only provide information concerning typical embodiments of the invention and are not therefore to be considered limiting in scope:

FIG. 1 schematically illustrates a perspective view of a first aquaponics system;

FIG. 2 is an exploded view of the first aquaponics system;

FIGS. 3a and 3b are perspective views of the basic structure of the first aquaponics system;

FIG. 4 is a perspective view of a second aquaponics system;

FIG. 5 is an exploded view of the second aquaponics system;

FIG. 6 is a perspective view of a third aquaponics system;

FIG. 7 is a perspective view of a fourth aquaponics system; and

FIG. 8 is an exploded view of an aquaponics system and a box for housing the aquaponics system.

### DETAILED DESCRIPTION

The principles and operation of an aquaponics system according to the present invention may be understood with reference to the figures and the accompanying description wherein similar components appearing in different figures are denoted by identical reference numerals. The drawings and descriptions are conceptual only. In actual practice, a single component can implement one or more functions; alternatively or in addition, each function can be implemented by a plurality of components and devices. In the figures and descriptions, identical reference numerals indicate those components that are common to different embodiments or configurations. Identical numerical references (even in the case of using different suffix, such as 5, 5a, 5b and 5c) refer to functions or actual devices that are either identical, substantially similar, or having similar functionality. It will be readily understood that the components of the present invention, as generally described and illustrated in the figures herein, could be arranged and designed in a wide variety of different configurations. Thus, the following more detailed description of the embodiments of the present invention, as represented in the figures herein, is not intended to limit the scope of the invention, as claimed, but is merely representative of embodiments of the invention. It is to be understood that the singular forms “a”, “an”, and “the” herein include plural referents unless the context clearly dictates otherwise. By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

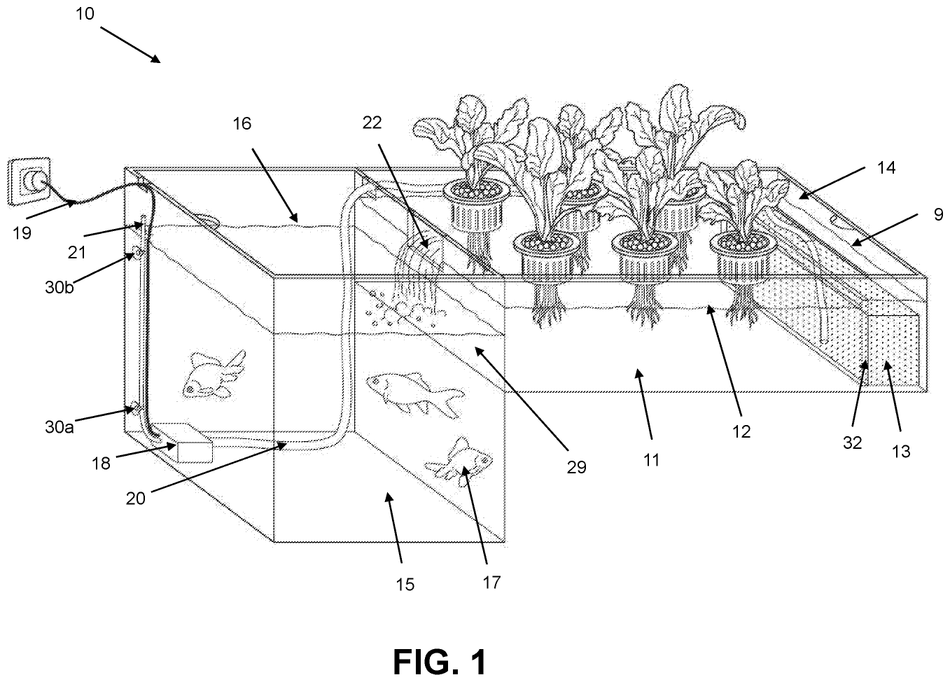

FIGS. 1-3b illustrate various views of a first aquaponics system 10. The aquaponics system 10 is a self-contained system that comprises a container 11 is used as a hydroponic part for growing plants, a fish tank 15 is used for housing aquatic fauna such as fish 17, and a compartment 14. The compartment 14 comprises a bio-filter 13 for capturing excrement and other waste, creating bacteria that is vital to the ecosystem and maintaining a healthy environment for the fish 17. The compartment 14 is separated from the container 11 by a wall 32. A vertical wall 29 separates the container 11 and the fish tank 15.

The wall 32 prevents un-filtered water to flow into the container 11 and allows easy replacement of the bio-filter 13.

A water feeding pump 18 is placed in the fish tank 15, comprising a feeding pipe 20, an air tube 21 and a power supply cord (cable) 19. The air tube 21 can be mounted to the fish tank 15 side (or wall) using vacuum cups 30a and 30b. The power supply cable 19 is shown connected to a common domestic AC power, but may as well be powered by other electric sources, solar or batteries. A water feeding pump may also comprise only a feeding pipe and a power supply cord.

The length of the container 11 and the compartment 14, as shown in FIG. 1, is being about 75% of the length of the aquaponics system 10 and the fish tank 15 is approximately 25% of the length of the entire system structure. The container 11 is shown as having a first water level 12, the fish tank 15 is shown as having a second water level 16, and the compartment 14 is shown as having a third water level 9. The second water level 16 is preferably lower than the first water level 12. The third water level 9 is preferably higher than the first water level 12.

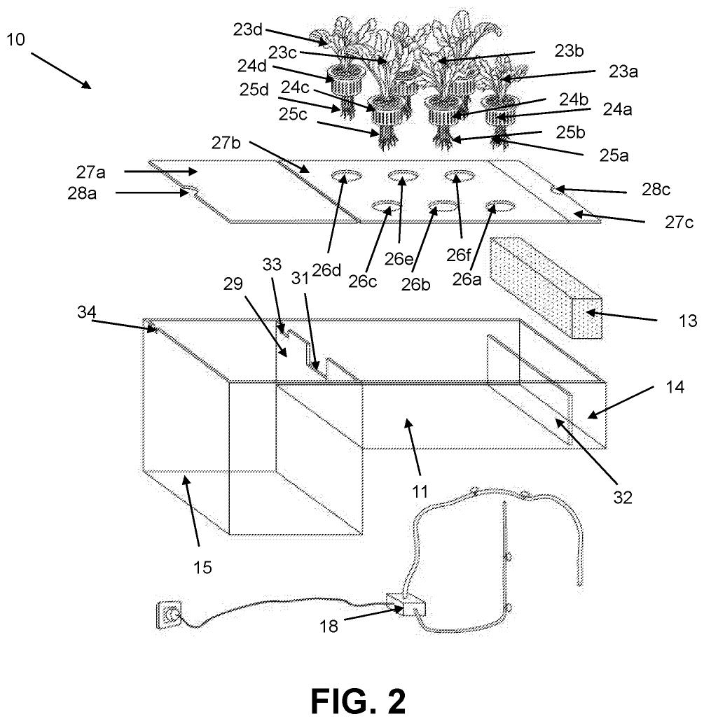

The water feeding pump 18 pumps water from the fish tank 15 and causes the fluids to flow through the feeding pipe 20 directly into the bottom of the compartment 14. The fluids stream through the bio-filter 13 for fertilization of the water. When the water level 9 exceeds the wall 32, the water is poured into the container 11. When the water level 12 exceeds an opening, shown in FIG. 2, in the wall 29, the water is poured back into the fish tank 15 forming a waterfall 22. The water is then fed again to the pump 18, and so forth. The fluids stream is continuous with no predetermination of volume or speed.

FIG. 2 is an exploded view of the aquaponics system 10. The aquaponics system 10 is a single enclosure comprises the container 11, the fish tank 15 and the compartment 14. The container 11 and the fish tank 15 are separated by the vertical wall 29 having recesses or openings 31 and 33. The container 11 and the compartment 14 are separated by the wall 32. The fish tank 15 is having a recess 34 that is configured to match the power supply cable 19. The power supply cable 19 passes through the recess 34 for esthetic look of the aquaponics system 10.

The feeding pipe 20 configured to match the recess 33, passes through the recess 33 into the bottom of the compartment 14.

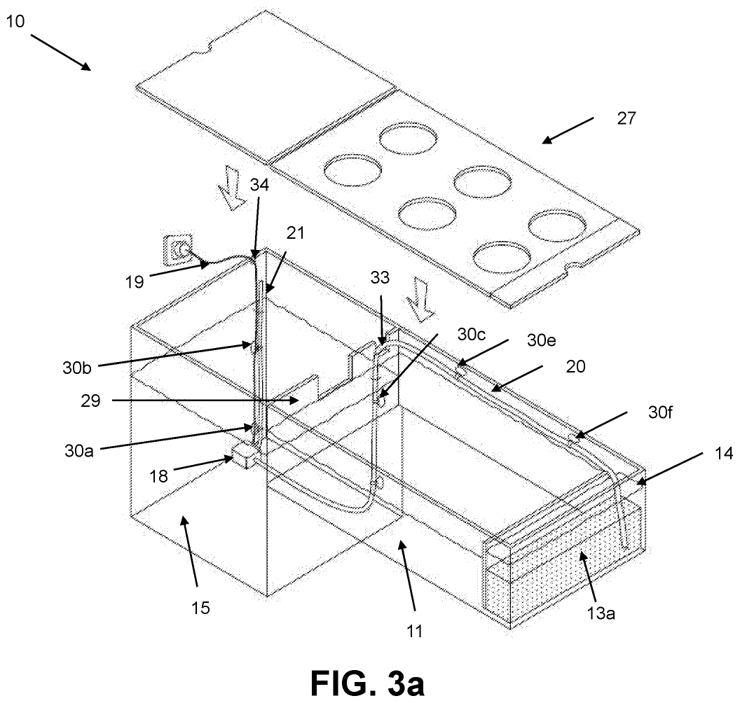

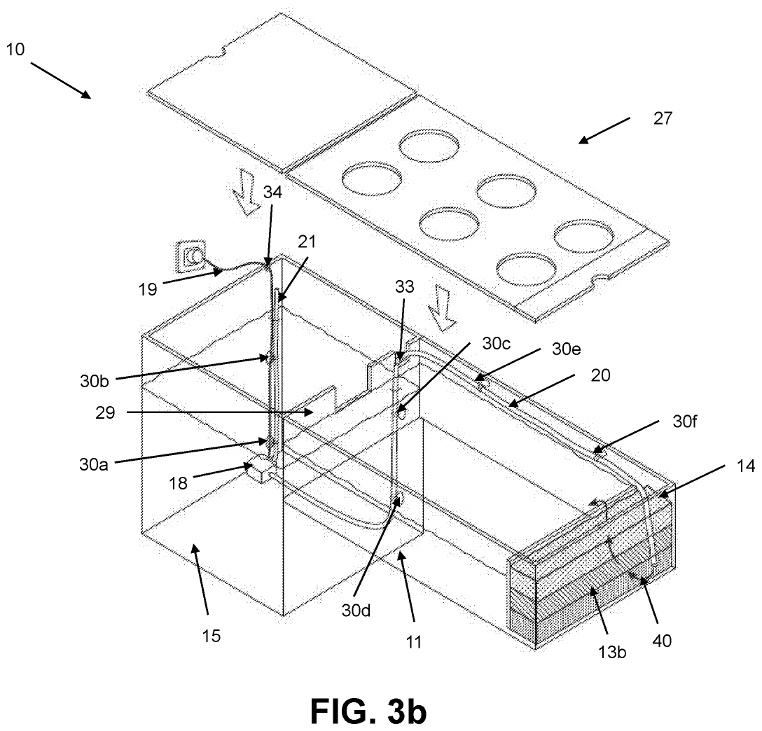

The aquaponics system 10 further comprises a cover 27, shown in FIGS. 3a-3b, divided into three parts. A first part 27a for covering the fish tank 15, a middle part 27b for covering the container 11, and a third part 27c for covering the compartment 14. The cover 27 can be also a single cover for covering all parts or separate covers for covering each part separately.

The first and third parts 27a and 27c are respectively comprising recesses 28a and 28c to enable opening of the system by removing of part 27a and providing access for handling the fish tank, and of part 27c, for replacing the bio-filter 13. The middle part 27b includes holes or openings 26a, 26b, 26c, 26d, 26e and 26f, used for respectively placing filled pot nets 24a, 24b, 24c, 24d, 24e and 24f. Plants 23a, 23b, 23c, 23d, 23e and 23f, are respectively placed in pot nets 24a, 24b, 24c, 24d, 24e and 24f in a way that the respective plants roots 25a, 25b, 25c, 25d, 25e and 25f penetrate through the open bottom of the pot net. After being mounted, the plants roots 25a, 25b, 25c, 25d, 25e and 25f are, partially or fully, immersed in the water of the container 11, as shown in FIG. 1. Each pot net is filled with a layer of an inert medium, such as hydroton, perlite, rockwool, clay pellets, peat moss or gravel.

Plants such as spices, vegetables, flowers, ornamental plants, herbs and others can be planted in the pot net. Fish such as goldfish, Koi fish, guppy fish (a.k.a millionfish and rainbow fish), Plecostomus and others can be put in the fish tank. Types of bio filters that can be used are square matala media, JBL Symec XL Filterwool.

FIGS. 3a and 3b are perspective views of the aquaponics system 10 having respectively different types of filters 13a and 13b. In FIGS. 3a and 3b, the air tube 21 is attached to the fish tank 15 using vacuum cups 30a and 30b, and the feeding pipe 20 passes through the recess 33 and is attached to the fish tank 15 using vacuum cups 30c and 30d, and to the container 11 with vacuum cups 30e and 30f.

The feeding pipe 20 reaches to the bottom of the compartment 14. FIG. 3b illustrates the flow of water 40 from the compartment 14 to the container 11.

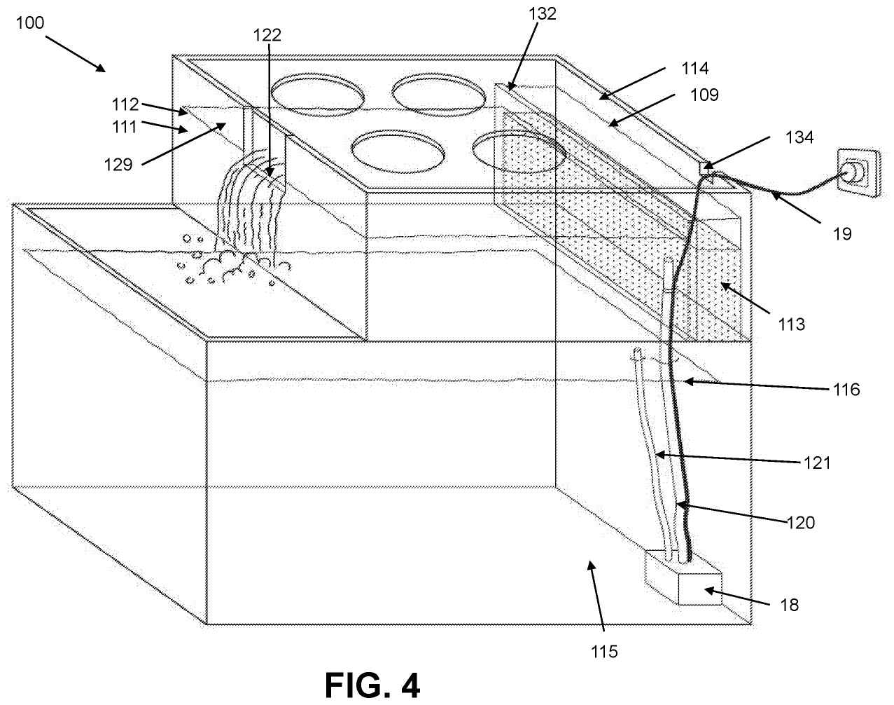

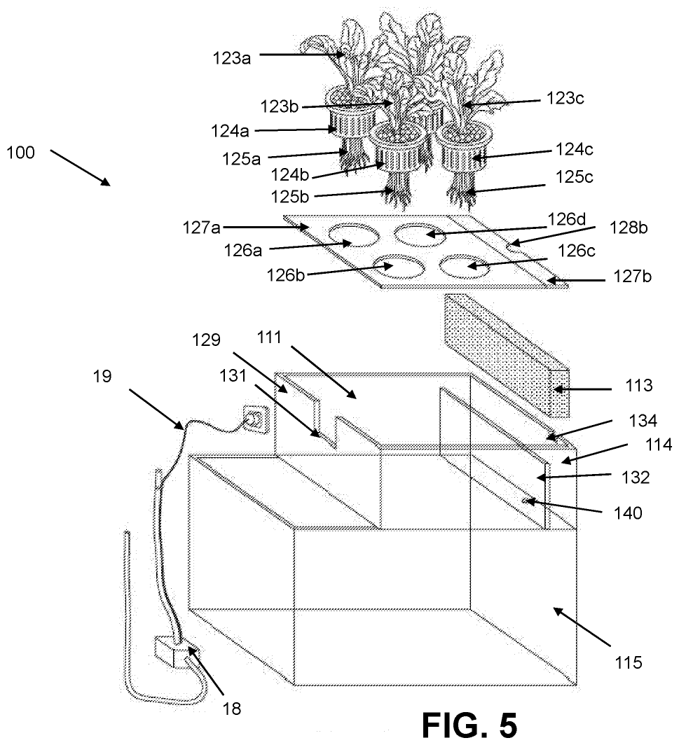

Another example of an aquaponics system 100 is shown in FIGS. 4-5. The aquaponics system 100 is a self-contained system that comprises a container 111 that is a hydroponic part for growing plants, a fish tank 115 for housing aquatic fauna, and a compartment 114. The compartment 114 comprises a bio-filter 113 for capturing excrement and other waste, creating bacteria that is vital to the ecosystem and maintaining a healthy environment for fish. A water feeding pump 18 is placed in the fish tank 115 comprises a feeding pipe 120, an air tube 121 and a power supply cord (cable) 19. The compartment 114 having a recess 134 that is configured to match the power supply cable 19. The power supply cable 19 passes through the recess 134 for esthetic look of the aquaponics system 100. The container 111 is shown as having a first water level 112, the fish tank 115 is shown as having a second water level 116, and the compartment 114 is shown as having a third water level 109. The second water level 116 is preferably lower than the first water level 112. The third water level 109 is preferably higher than the first water level 112.

The container 111 is placed above the fish tank 115. The feeding pipe 120 is entered to the compartment 114 through a hole, shown in FIG. 5. The water feeding pump 18 pumps water from the fish tank 115 and causes the fluids to flow through the feeding pipe 120 directly into the bottom of the compartment 114. The fluids stream through the bio-filter 113 for fertilization.

When the water level 109 exceeds the wall 132, the water is poured into the container 111. When the water level 112 exceeds an opening, shown in FIG. 5, in wall 129, the water is poured back into the fish tank 115 forming a waterfall 122. The water is then fed again to the pump 18, and so forth.

In another example of the system the first container may contain the second container, where the first container may be rectangular or cuboid shaped having four side walls, and the second container may be rectangular or cuboid shaped having at least one shared side wall with the first container and a floor. One of the side walls of the second container may comprise a recess, an opening, or a slit that may determine a pre-set water level.

FIG. 5 is an exploded view of the aquaponics system 100. The wall 129 of the container 111 having a recess or opening 131. The compartment 114 is separated from the container 111 by a wall 132. The compartment 114 comprising a hole 140 in its bottom part for the insertion of the feeding pipe 120 into the compartment 114 for fertilizing of the water in the bio-filter 113.

The aquaponics system 100 further comprises a cover divided into two parts 127a and 127b. The first part 127a for covering the container 111 and the second part 127b for covering the compartment 114. The second part 127b comprises a recess 128b to enable opening of the compartment 114, and providing access for easy replacement of the bio-filter 113.

The first part 127a includes holes or openings 126a, 126b, 126c, and 126d, used for respectively placing filled pot nets 124a, 124b, 124c, and 124d. Plants 123a, 123b, 123c, and 123d, are respectively placed in pot nets 124a, 124b, 124c, and 124d in a way that the respective plants roots 125a, 125b, 125c, and 125d penetrate through the open bottom of the pot net. After being mounted, the plants roots 125a, 125b, 125c, and 125d are, partially or fully, immersed in the water of the container 111. Each pot net is filled with a layer of an inert medium, such as hydroton, perlite, rockwool, clay pellets, peat moss or gravel.

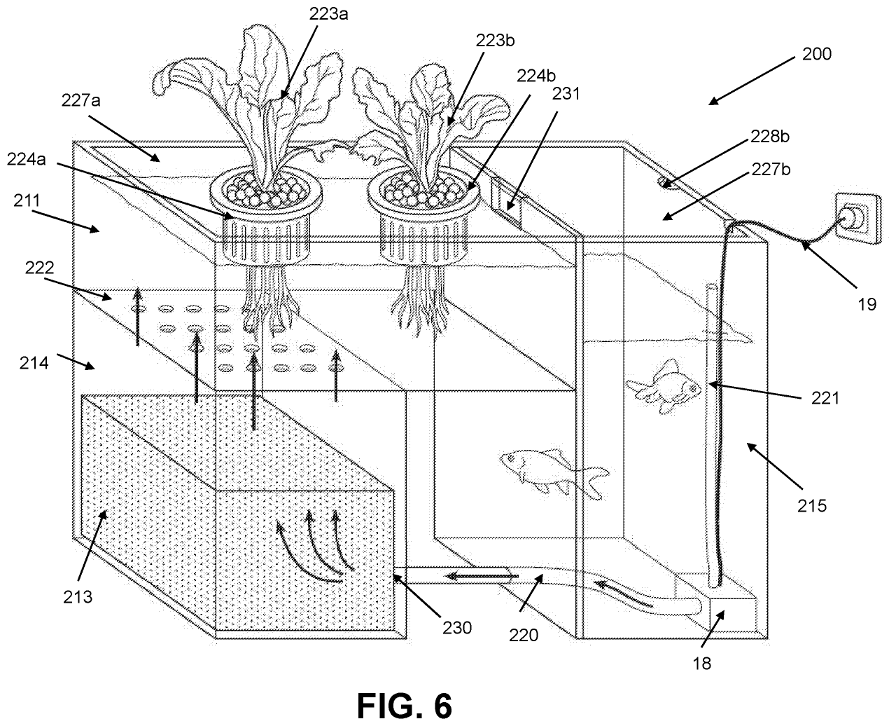

FIG. 6 is a perspective view of another example of an aquaponics system 200. The aquaponics system 200 is a self-contained system that comprises a container 211, a fish tank 215 and a compartment 214. The container 211 is used as hydroponic part for growing plants. The fish tank 215 is used for housing aquatic fauna. The compartment 214 containing a bio-filter 213 for capturing excrement and other waste, creating bacteria that is vital to the ecosystem and maintaining a healthy environment for fish. A water feeding pump 18 is placed in the fish tank 215, comprises a feeding pipe 220, an air tube 221 and a power supply cord (cable) 19.

The container 211 is partial placed above the compartment 214. A holed bather 222 separates between the container 211 and the compartment 214. The feeding pipe 220 is entered to the compartment 214 through a hole 230 in the side wall of the compartment 214.

The aquaponics system 200 further comprises a cover divided into two parts 227a and 227b. The first part 227a for covering the container 211 and the second part 227b for covering the fish tank 215. The second part 227b comprises a recess 228b to enable opening of the fish tank 215, and providing an access for handling the fish tank 215.

The first part 227a and the holed barrier 222 can be removed to enable an access to the compartment 214 for replacing the bio-filter 213.

The first part 227a includes holes or openings is used for placing filled pot nets 224a and 224b. Plants 223a and 223b are respectively placed in pot nets 224a and 224b in a way that the plants roots penetrate through the open bottom of the pot net. After being mounted, the plants roots are, partially or fully, in the water of the container 211. The water feeding pump 18 pumps water from the fish tank 215 through the feeding pipe 220 directly into the compartment 214 through the hole 230. The fluids stream through the bio-filter 213 for fertilization. The fluids then flow to the container 211 through the holed barrier 222. When the water exceeds an opening 231, the water is poured back into the fish tank 215 forming a waterfall. The water is then fed again to the pump 18, and so forth.

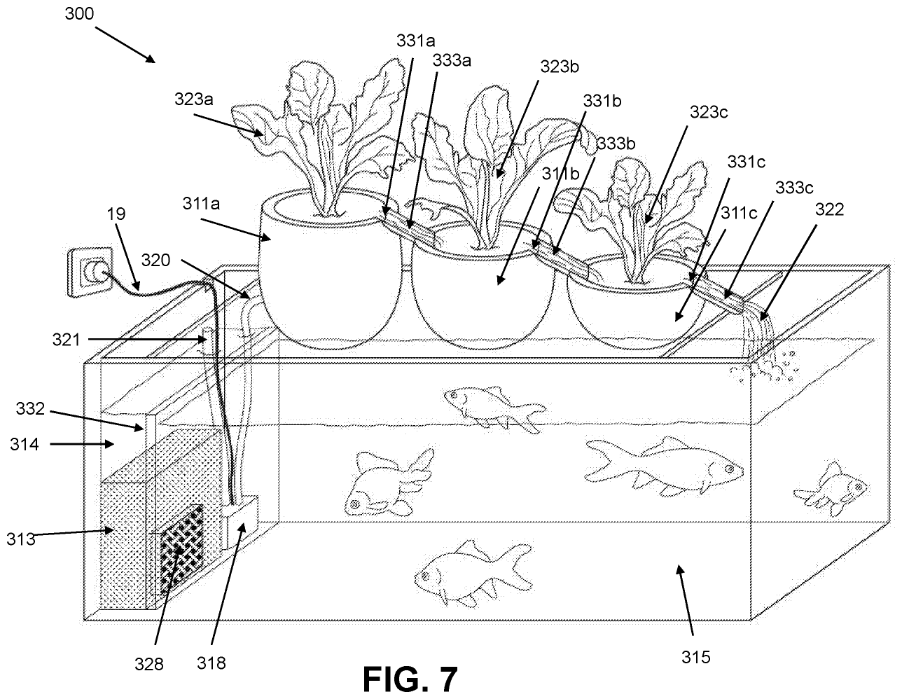

FIG. 7 is a perspective view of another example of an aquaponics system 300. The aquaponics system 300 comprises a rectangular fish tank 315, three bowl containers 311a, 311b and 311c, and a compartment 314. The compartment 314 and the fish tank 315 are separated by a vertical wall 332 having a perforated area 328. The vertical wall 332 prevents the water of the compartment 314 to proud into the fish tank 315.

The containers 311a, 311b and 311c are in increased shape and are for growing plants. The containers 311a, 311b and 311c respectively comprise a recess or opening 331a, 331b and 331c. The containers 311a, 311b and 311c are respectively linked by three diagonal surfaces 333a, 333b and 333c. At least one plant 323a, 323b and 323c can be planted in each respective container 311a, 311b and 311c. The at least one plant 323a, 323b and 323c is placed in a filled pot net in such a way that the plant roots penetrate through the open bottom of the pot net. After being mounted, the at least plant roots are, partially or fully, immersed in the water of each respective container 311a, 311b and 311c.

A water feeding pump 318 is placed in the compartment 314. The water feeding pump 318 comprises a feeding pipe 320, an air tube 321 and a power supply cord (cable) 19. The water feeding pump 318 pumps water from the fish tank 315. The pumping action causes the fluids flow through the perforated area 328 into the bio-filter 313. The filtered water flows through the feeding pipe 320 to the first container 311a. When the water level of container 311a exceeds the opening 331a, the water then flows on the diagonal surface 333a to the second container 311b. When the water level of the second container 311b exceeds the opening 331b, the water then flows on the diagonal surface 333b to the third container 311c. When the water level of the third container 311c exceeds the opening 331c, the water flows on the diagonal surface 333c back into the fish tank forming a waterfall 322. The water is then fed again to the pump 318, and so forth. The flow of water in system 300 creates circulation of water from the fish tank 315 to the large bowl 311a, then to a smaller bowl 311c and back to the fish tank 315.

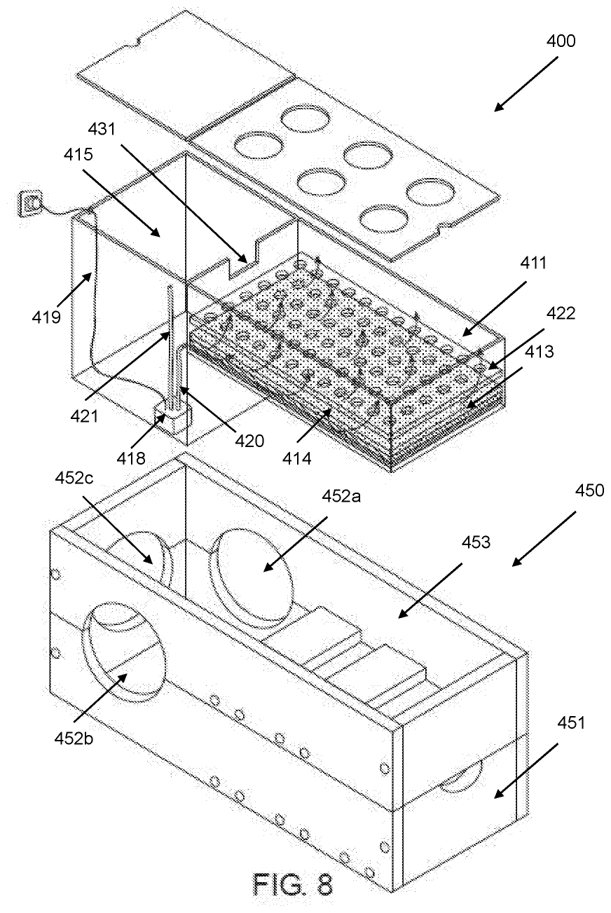

FIG. 8 is an exploded view of an aquaponics system 400 and a box 450 for housing the aquaponics system 400 or any aquaponics system that fits the box 450 such as the aquaponics system, as shown in FIG. 1. The aquaponics system 400 comprises a container 411 for growing plants, a fish tank 415 for housing aquatic fauna and a compartment 414. A holed barrier 422 separates between the container 411 and the compartment 414. The compartment 414 containing a bio-filter 413 for capturing excrement and other waste, creating bacteria that is vital to the ecosystem and maintaining a healthy environment for fish.

A water feeding pump 418 is placed in the fish tank 415, comprising a feeding pipe 420, an air tube 421 and a power supply cord (cable) 419.

The water feeding pump 418 pumps water from the fish tank 415 and causes the fluids to flow through the feeding pipe 420 directly into the bottom of the compartment 414. The fluids stream through the bio-filter 413 for fertilization and then flow through the holed barrier 422 into the container 411. When the water level of the container 411 exceeds an opening in the wall 431, the water is poured back into the fish tank 415 forming a waterfall. The water is then fed again to the pump 418, and so forth.

The box 450 contains two parts. The first part comprising three view holes 452a, 452b and 452c. The holes may be in any geometrical shape. The second part having a base 453. The box 450 can be made of wood or plastic or any other suitable material.

When placing the container 411 and the fish tank 415 inside the box 450, the fish tank 415 is inserted to the first part and the container 411 is placed in the second part 452. In such a way the fish that live in the fish tank 415 can be seen through the view holes 452a, 452b and 452c. The box 450 may also comprise a drawer 451 for storage.

The terminology used herein is for the purpose of describing particular embodiments only, and is not intended to be limiting of the invention. As used herein, the singular forms “a”, “an” and “the” are intended to include the plural forms as well, unless the context clearly indicates otherwise. It will be further understood that the root terms “include” and/or “have”, when used in this specification, specify the presence of stated features, integers, steps, operations, elements, and/or components, but do not preclude the presence or addition of one or more other features, integers, steps, operations, elements, components, and/or groups thereof. The terms “plurality” and “a plurality” as used herein includes, for example, “multiple” or “two or more”. For example, “a plurality of items” includes two or more items.

Although exemplary embodiments of the present invention have been described, this should not be construed to limit the scope of the appended claims. Those skilled in the art will understand that modifications may be made to the described embodiments. Moreover, to those skilled in the various arts, the invention itself herein will suggest solutions to other tasks and adaptations for other applications. It is therefore desired that the present embodiments be considered in all respects as illustrative and not restrictive, reference being made to the appended claims rather than the foregoing description to indicate the scope of the invention.

All publications, patents, and patent applications cited in this specification are incorporated herein by reference as if each individual publication, patent, or patent application were specifically and individually indicated to be incorporated by reference and set forth in its entirety herein.

1. A self-contained closed aquaponics system comprising:
a first container configured to serve as an aquarium tank for containing aquatic animals and configured for containing water;
a second container for growing plants configured for containing water at a first water level;
a bio-filter in the second container for fertilization of the water in the system;
a pipe for transferring water from the first container to the bottom of the bio-filter;
an electric pump connected to the pipe for streaming water from the first container to the bio-filter via the pipe; and
a power supply cord for providing power connected to a common domestic AC power for providing electric power to the pump,
wherein the first container is attached to the second container, and wherein when the first water level exceed a pre-set water level, water are poured from the second container to the first water container so that the water level at the second water container does not exceed the pre-set water level.

2. The system according to claim 1, wherein the first container is rectangular or cuboid shaped having four side walls, and wherein the first and second containers are attached side-by-side, wholly or partially.

3. The system according to claim 1, wherein the second container is rectangular or cuboid shaped having four side walls, and wherein the first and second containers are attached side-by-side, wholly or partially.

4. The system according to claim 3, wherein the first container is rectangular or cuboid shaped having four side walls, and wherein a vertical side wall is shared between the first and second containers.

5. The system according to claim 4, wherein the shared side wall having a recess, an opening, or a slit that determines the pre-set water level.

6. The system according to claim 1, for use with one or more soilless pot net baskets housing plants, the system further comprising a cover for covering at least part of the second container, the cover comprises one or more openings for mounting pot nets therein.

7. The system according to claim 6, wherein the openings are circular or rectangular shaped, and wherein the roots of the plants in the pot nets are immersed in the water in the second container.

8. The system according to claim 1, wherein the material of the first or second container comprises Acrylonitrile Butadiene Styrene (ABS), High-Density Polyethylene (HDPE), Poly Vinyl Chloride (PVC), polycarbonate, acrylic, or glass.

9. The system according to claim 1, wherein the aquatic animals comprise snails, fish, crayfish or prawns.

10. The system according to claim 1, wherein the bio-filter is operative to capture excrement or waste from the aquatic animals in the first container and to filter out materials that affect the health of the aquatic animals.

11. The system according to claim 10, wherein the bio-filter is further operative to nitrifying bacteria into nitrites and subsequently into nitrates that are used as nutrients by the plants in the second container.

12. The system according to claim 10, wherein the bio-filter comprises, or is based on, a sponge filter, a corner filter, a Hang On Back/Power (HOB) Filters, a canister filters, a Fluidized Bed Filter (FBF), a foam cartridge filter, an undergravel filter, square matala media, JBL Symec, or XL Filterwool.

13. The system according to claim 10, wherein the bio-filter comprises, or is based on, algae.

14. The system according to claim 1, wherein the bio-filter is separately located in the second container.

15. The system according to claim 14, wherein the second container comprises a dedicated compartment for housing the bio-filter.

16. The system according to claim 15, wherein the second filter comprises a vertical wall for forming the compartment for housing the bio-filter between the vertical wall and one of the side walls of the second container.

17. The system according to claim 16, wherein when water in the compartment exceeds a pre-set water level, water are poured from the compartment.

18. The system according to claim 16, wherein the vertical wall defines a wall height that determines the pre-set water level.

19. The system according to claim 1, wherein the length, the width, the height, the area, or the volume of the first container is less than 70%, 60%, 50%, 40%, 30%, 20%, or 10% of the respective length, width, height, area, or volume of the second container.

20. The system according to claim 1, wherein the length, the width, the height, the area, or the volume of the second container is less than 70%, 60%, 50%, 40%, 30%, 20%, or 10% of the respective length, width, height, area, or volume of the first container.

21. The system according to claim 1, further comprising a single cover for covering at least part of the first container and at least part of the second container.

22. The system according to claim 21, wherein the cover is a flat plate for covering most of the first and second containers.

23. The system according to claim 22, wherein the cover is configured to allow access for replacing the bio-filter.

24. The system according to claim 1, wherein a vertical side wall is shared between the first and second containers, and wherein the vertical side comprises an opening or a recess for passing through of the pipe between the first and second containers.

25. The system according to claim 1, further comprising a cover for covering at least part of the second water container, the cover comprises one or more openings and one or more soilless pot net baskets mounted therein, wherein the pot net baskets comprise a plant in an inert medium.

26. The system according to claim 25, wherein the inert medium comprises, or is based on, hydroton, perlite, rockwool, clay pellets, or gravel, and wherein the plant comprises, or is based on, a spice, a vegetable, a flower, an ornamental plant, a herb.

27. The system according to claim 1, wherein the bio-filter comprises multiple layers of different materials.

28. The system according to claim 1, wherein the second container is located above the first container.

29. The system according to claim 28, wherein the first container is rectangular or cuboid shaped having four side walls.

30. The system according to claim 28, wherein the second container is rectangular or cuboid shaped having four side walls and a floor.

31. The system according to claim 30, wherein the first container is rectangular or cuboid shaped having four side walls and a cover covering at least part of the first container, and wherein the cover of the first container is the floor of the second container.

32. The system according to claim 30, wherein one of the side walls comprises a recess, an opening, or a slit that determines the pre-set water level.
